(19) United States
(12) Patent Application Publication
(10) Pub. No.: US 2026/0322488 A1
(43) Pub. Date: Oct. 15, 2026

(54) Apparatus, Access Point and Distributed Mutli-Antenna Communication System

(71) Applicant: Telefonaktiebolaget LM Ericsson (publ), Stockholm (SE)

(72) Inventors: Alessandra Bigongiari, Pisa (IT); Rafael Puerta, Sundbyberg (SE); Filippo Ponzini, Pisa (IT)

(21) Appl. No.: 19/484,289

(22) PCT Filed: May 17, 2023
(86) PCT No.: PCT/EP2023/063351

§ 371 Date: Nov. 13, 2025

(51) Int. Cl. H04B 10/071; H04W 56/00; H04W 88/08

(52) U.S. Cl. CPC H04B 10/071; H04W 56/001; H04W 88/085

(57) ABSTRACT

An apparatus (100), for use in a distributed multi-antenna communication system, configured to transmit downlink, DL, data signals on DL fronthaul optical signals to access points, APs, and receive uplink, UL, data signals on UL fronthaul optical signals from APs. The apparatus comprises: optical time domain reflectometry, OTDR, apparatus (120, 170, 190, 470) configured to: transmit optical interrogation signals to APs; receive reflected optical interrogation signals from APs; and determine using the received reflected optical interrogation signals respective travel times from the apparatus to APs; and digital signal processing, DSP, apparatus (130) operative to determine DL travel time compensations for DL data signals to be transmitted to a plurality of APs, the DL travel time compensations based on respective travel times and configured to cause the DL data signals to be synchronized at the APs for coherent joint transmission by the APs to a user equipment, UE. The apparatus is configured to apply the DL travel time compensations to the DL data signals.

### TECHNICAL FIELD

The invention relates to an apparatus for a distributed multi-antenna communication system. The invention further relates to an access point for a distributed multi-antenna communication system. The invention further relates to a distributed multi-antenna communication system.

### BACKGROUND

In a typical wireless communication network, wireless devices, also known as wireless communication devices, mobile stations, stations (STA) and/or User Equipments (UE), communicate via a Local Area Network such as a Wi-Fi network or a Radio Access Network (RAN) to one or more core networks (CN). The RAN covers a geographical area which is divided into service areas or cell areas, which may also be referred to as a beam or a beam group, with each service area or cell area being served by a radio access node such as a radio access node e.g., a Wi-Fi access point or a radio base station (RBS), which in some networks may also be denoted, for example, a NodeB, eNodeB (eNB), or gNB as denoted in 5G. A service area or cell area is a geographical area where radio coverage is provided by the radio access node. The radio access node communicates over an air interface operating on radio frequencies with the wireless device within range of the radio access node.

Cell-based mobile networks offer a good and almost uniform connectivity, but they suffer from some inherent problems that are calling into question their use for the next generation. Cell-based architecture offers high spectral efficiency close to the antenna (cell center) which drops fast at the cell borders. Such behaviour is mainly due to the interference from the adjacent cells. This hasn't been a big problem in the past, as mobile networks were only used to carry voice traffic. As network change from carrying voice traffic to being high-capacity data networks, the existing inefficient use of spectrum has begun to show its limits, as it has a detrimental effect on the entire network capacity.

A Multiple-Input Multiple-Output (MIMO) communications system is a system where a base station's antenna comprises multiple transmitting and receiving elements co-located in a single array in a cell centre to enable spatial multiplexing. The introduction of Massive MIMO in cell-based mobile networks has allowed to increase the overall capacity and mitigate the drop of the spectral efficiency at the cell edge. Unfortunately, this has only mitigated but not resolved the cell-edge interference and therefore the drop in spectral efficiency.

A new approach is based on the concept of cell-free mobile networks, as reported by Interdonato, G., Björnson, E., Quoc Ngo, H. et al., “Ubiquitous cell-free Massive MIMO communications”, J Wireless Com Network 2019, 197 (2019). Each UE has visibility of multiple Access Points (AP) and, when active, the UE is simultaneously connected to multiple APs. More specifically, each UE is served by a selected subset of APs (user-specific cluster) and all the APs that supports a UE take other APs interference into consideration. This approach eliminates the cell boundaries resulting in no inter-cell interference, with consistent benefits in terms of spectral efficiency and then optimization of radio resources.

A Distributed Multiple-Input Multiple-Output (D-MIMO) communications system is a system where a base station's antennas are spatially distributed. To benefit from the reduction of edge interference offered by a “cell-free” D-MIMO network, and therefore from the increase in terms of network capacity and spectral efficiency, a precise synchronization of the adjacent APs is required to achieve coherent joint transmissions (CJT).

Joint transmission schemes are used for the simultaneous transmission from multiple APs to the same UE. One of the schemes used in coordinated multi-point (COMP) technology is joint processing including joint transmission (JT) and reception. JT may include two approaches: non-coherent (NCJT) and coherent joint transmission (CJT).

In NCJT, the network does not use detailed channel information in the joint transmission and in the majority of cases no radio frequency (RF) phase coherency is achieved. Therefore, a main gain that may be eventually achieved by NCJT is that the power of several APs is used to serve the same UE, i.e., a power gain. The use of distributed APs may still provide a significant macro diversity gain also when NCJT is used.

Conversely, in CJT, the detailed channel information between the UE and two or more APs involved in the JT is used to calculate the transmission precoding weights of all APs. In principle, by means of CJT the greatest MIMO gains can be realized, i.e., diversity and power gains. On the other hand, CJT requires stringent requirements on the time synchronization and relative phase coherency of the cooperating APs which may increase the complexity of its implementation. It is noted that in communication systems where channel reciprocity holds (e.g., TDD), calibration and precoding schemes to achieve CJT may be relaxed.

A centralized Radio Access Network (C-RAN) architecture, also referred to as cloud RAN architecture, is an appealing way of implementing D-MIMO since most of the digital signal processing (DSP) is centralized in a Apparatus (CU) with sufficient resources, while the complexity of the APs may be reduced. However, most of the current C-RAN solutions use digital optical interfaces for the FrontHaul (FH) links, e.g., Common Public Radio Interface (CPRI), enhanced CPRI (eCPRI) or Open Base-Station Architecture Initiative (OBSAI) interfaces. Consequently, in the APs a digital interface termination and all the DSP of a digital front-end (DFE) is needed.

Conventional digital FH interfaces, e.g., CPRI and eCPRI, used in today's D-MMO systems may not be practical for CJT since it is difficult to measure the delay of the corresponding digital FH links without relying on additional techniques, e.g., Global Navigation Satellite System (GNSS). However, measuring the delay with GNSS may lead to excessive overhead between the APs and/or the CU and extensive DSP in each AP to achieve the desired synchronization.

A problem that needs to be solved is how to ensure that the FH links of D-MIMO network are sufficiently synchronized to enable CJT, while using a conventional architecture, namely, using CPRI/eCPRI FH interfaces. It is noted that sub-nanosecond level time synchronization is required for CJT and conventional digital interfaces are capable only of tens of nanosecond level time synchronization.

If the APs serving a UE are not synchronized and their RF transmissions are not phase aligned, only NCJT is possible. Consequently, current D-MIMO systems do not fully take advantage of the benefits of MIMO and power gains.

Calibration by means of reciprocity/mutual-coupling schemes are known for conventional co-located MIMO phased arrays. Thus, it is not obvious how to calibrate and compensate a D-MIMO network using digital fronthaul interfaces where the APs are not co-located and the distance between them is not constant (the distances between APs can vary from few meters to hundreds of meters). PCT/EP2021/081969 describes a method of transmitting downlink, DL, radio signals in a D-MIMO system using analog fronthaul links of a RAN in which the DL radio signals transmitted by different APs are synchronized by transmitting additional calibration radio signals between the APs.

### SUMMARY

It is an object to provide an improved apparatus for a distributed multi-antenna communication system. It is a further object to provide an improved access point for a distributed multi-antenna communication system. It is a further object to provide an improved distributed multi-antenna communication system.

An apparatus for use in a distributed multi-antenna communication system, the apparatus configured to transmit downlink, DL, data signals on DL fronthaul optical signals to access points, APs, and receive uplink, UL, data signals on UL fronthaul optical signals from APs. The apparatus comprises optical time domain reflectometry, OTDR, apparatus and digital signal processing, DSP, apparatus. The OTDR apparatus is configured to transmit optical interrogation signals to APs, receive reflected optical interrogation signals from APs and determine using the received reflected optical interrogation signals respective travel times from the apparatus to APs. The DSP apparatus comprises an interface, at least one processor and memory. The memory contains instructions executable by said processor whereby the DSP apparatus is operative as follows. The DSP apparatus is operative to determine DL travel time compensations for DL data signals to be transmitted to a plurality of APs. The DL travel time compensations are based on the respective travel times and are configured to cause the DL data signals to be synchronized at said plurality of APs for coherent joint transmission by said plurality of APs to a same user equipment, UE. The apparatus is further configured to apply the DL travel time compensations to the DL data signals to be transmitted to said plurality of APs.

The apparatus may enable the radio transmission from APs of a distributed multi-antenna communication system, for example a D-MIMO system, to be sufficiently synchronized to enable coherent joint transmissions (CJTs), while using a conventional architecture, for example using CPRI/eCPRI fronthaul interfaces. The apparatus may enable robust sub-nanosecond level time synchronization (i.e. radio signal phase and time synchronization) based on the OTDR measurement of respective travel times from the apparatus to APs. The OTDR-based time synchronization may enable the digital signal to be synchronized in a way that is compatible with conventional digital fronthaul interfaces, e.g., CPRI/eCPRI, while enabling Coherent Joint Transmission a distributed multi-antenna communication system. The apparatus may enable the DSP required to achieve synchronization to be centralized thereby reducing the complexity of the distributed APs within the system. The apparatus advantageously does not require any exchange of information between the APs, since the synchronization process is centralized at the apparatus, avoiding unnecessary overhead through the fronthaul links and thus higher data rates.

In an embodiment, the optical interrogations signals are one of amplitude modulated optical signals or pulsed optical signals.

In an embodiment, the OTDR apparatus is additionally configured to determine using the received reflected optical interrogation signals respective optical power losses between the apparatus and APs. The apparatus is additionally configured to modify optical powers of DL fronthaul optical signals to cause the optical powers of the DL fronthaul optical signals to be equalized at said plurality of APs. The apparatus advantageously enables FH optical signal equalization to be centralized.

In an embodiment, the DL data signals and the UL data signals comprise one of common public radio interface, CPRI, or evolved common public radio interface, eCPRI, user plane data. The use of digital fronthaul interfaces has the advantage of avoiding the problem of linearity in electro-optical conversion. The OTDR-based time synchronization advantageously enables DL and UL data signals to be synchronized.

In an embodiment, the apparatus has a single optical input/output port configured for connection to a bi-directional optical fibre link. The apparatus is configured to output DL fronthaul optical signals and optical interrogation signals through the input/output port and the apparatus is configured to receive UL fronthaul optical signals and reflected optical interrogation signals through the input/output port. The apparatus may advantageously be deployed within a distributed multi-antenna communication system having single, bi-directional optical links between the CU and respective APs.

In an embodiment, the apparatus has a first optical port configured for connection to a DL optical fibre link and a second optical port configured for connection to an UL optical fibre link. The apparatus is configured to output DL fronthaul optical signals through the first optical port, receive UL fronthaul optical signals through the second optical port, and output optical interrogation signals and receive reflected optical interrogation signals through one of the first optical port or the second optical port. The apparatus may advantageously be deployed within a distributed multi-antenna communication system having separate downlink and uplink optical links between the CU and respective APs.

In an embodiment, the DL fronthaul optical signals and the UL fronthaul optical signals are at a first wavelength, λ1, and the optical interrogation signals and the reflected optical interrogation signals are at a second, different, wavelength, λ2 The apparatus further comprises a wavelength selective router configured to separate reflected optical interrogation signals from UL fronthaul optical signals and to route reflected optical interrogation signals to the OTDR apparatus. The apparatus may enable respective travel times from the CU to APs to be determined alongside transmission of DL fronthaul optical signals and UL fronthaul optical signals.

In an embodiment, the apparatus is configured to transmit DL fronthaul optical signals and receive UL fronthaul optical signals within first time slots. The OTDR apparatus is configured to transmit optical interrogation signals and receive reflected optical interrogation signals within second time slots, different to the first time slots. This may enable operation of the apparatus without requiring a wavelength selective router for separating UL fronthaul optical signals and reflected optical interrogation signals, enabling the same wavelength to be used for both FH optical signals and the OTDR optical interrogation signals.

In an embodiment, the second time slots have a duration equal to or longer than an optical round trip time of a said optical interrogation signal from the apparatus to a respective AP of said plurality of APs located furthest from the apparatus and back to the apparatus. This may ensure that optical interrogation signals are not travelling in the fronthaul optical links at the same time as the DL fronthaul optical signals and the UL fronthaul optical signals, thus enabling the same wavelength to be used for both FH optical signals and the OTDR optical interrogation signals without any interference.

In an embodiment, the distributed multi-antenna communication system is a Distributed Multiple-Input Multiple-Output, D-MIMO, system.

In an embodiment, the apparatus is a central unit, CU. A single monolithic apparatus performing all baseband processing, may therefore be enabled.

In an embodiment, the apparatus is a fronthaul gateway, FHGW. A dedicated apparatus may therefore be provided for performing additional baseband functions for implementing CJT.

An aspect provides a access point for a distributed multi-antenna communication system. The access point comprises radio frequency, RF, antenna apparatus, an optical receiver, an optical transmitter and a wavelength selective optical reflector The RF antenna apparatus is operative to transmit RF downlink, DL, data signals and to receive RF uplink, UL, data signals. The optical receiver is configured to receive DL fronthaul optical signals carrying DL data signals from a apparatus and to convert the DL fronthaul optical signals carrying DL data signals into RF DL data signals for transmission by the RF antenna apparatus. The optical transmitter is configured to receive UL RF data signals and to convert the UL RF data signals into UL fronthaul optical signals carrying UL data signals for transmission to the apparatus. The wavelength selective optical reflector configured to reflect optical interrogation signals received from the apparatus.

The access point may enable radio transmissions within a distributed multi-antenna communication system, for example a D-MIMO system, to be sufficiently synchronized to enable coherent joint transmissions (CJTs), while using a conventional architecture, for example using CPRI/eCPRI fronthaul interfaces. The access point may enable robust sub-nanosecond level time synchronization (i.e. radio signal phase and time synchronization) based on the OTDR measurement of respective travel times from an apparatus, such as a CU or a FHGW, to APs. The OTDR-based time synchronization may enable the digital signal to be synchronized in a way that is compatible with conventional digital fronthaul interfaces, e.g., CPRI/eCPRI, while enabling Coherent Joint Transmission a distributed multi-antenna communication system. The DSP complexity of the AP is advantageously reduced. The AP advantageously does not require any exchange of information with other APs to achieve synchronization of radio transmissions.

In an embodiment, the RF antenna apparatus comprises an RF antenna and RF front end circuitry configured to receive RF DL data signals from the optical receiver and to process the RF DL data signals for transmission by the RF antenna. The access point further comprises digital signal processing, DSP, apparatus configured to compensate for amplitude and phase changes caused to the RF DL data signals by the RF front end circuitry. The DSP complexity of the AP is advantageously reduced since only signal processing relating to its own RF front end is required, excluding higher layers processing, e.g., channel estimation and precoding.

In an embodiment, the optical receiver is configured to receive DL fronthaul optical signals at a first wavelength, λ1, the optical transmitter is configured to transmit UL fronthaul optical signals at λ1, and the wavelength selective optical reflector is configured to reflect one of optical interrogation signals at the first wavelength, λ1, or optical interrogation signals at a second, different, wavelength, λ2.

In an embodiment, the access point has a single optical input/output port connected to the optical receiver and the optical transmitter, the input/output port is configured for connection to a bi-directional optical fibre link and the wavelength selective optical reflector is provided at the input/output port. The AP may advantageously be deployed within a distributed multi-antenna communication system having single, bi-directional optical links between the CU and respective APs.

In an embodiment, the access point has a first optical port connected to the optical receiver and configured for connection to a DL optical fibre link, and a second optical port connected to the optical transmitter and configured for connection to an UL optical fibre link. The wavelength selective optical reflector is provided at one of the first optical port or the second optical port. The AP may advantageously be deployed within a distributed multi-antenna communication system having separate downlink and uplink optical links between an apparatus, such as a CU or a FHGW, and respective APs.

In an embodiment, the access further comprises a second wavelength selective optical reflector configured to reflect optical interrogation signals at the same wavelength as the first wavelength selective optical reflector. The wavelength selective optical reflector is provided at the first optical port and the second wavelength selective optical reflector is provided at the second optical port. The AP may enable improved accuracy of measurement of the optical round trip time to the AP from an apparatus, such as a CU or a FHGW, of a distributed multi-antenna communication system.

In an embodiment, the distributed multi-antenna communication system is a Distributed Multiple-Input Multiple-Output, D-MIMO, system.

An aspect provides a distributed multi-antenna communication system comprising an apparatus configured to transmit downlink, DL, data signals on DL fronthaul optical signals to access points, APs, and receive uplink, UL, data signals on UL fronthaul optical signals from APs, a plurality of access points, APs, and a plurality of optical fibre links connecting the apparatus to the APs. The apparatus comprises optical time domain reflectometry, OTDR, apparatus and digital signal processing, DSP, apparatus. The OTDR apparatus is configured to transmit optical interrogation signals to APs, receive reflected optical interrogation signals from APs and determine using the received reflected optical interrogation signals respective travel times from the apparatus to APs. The DSP apparatus comprises an interface, at least one processor and memory. The memory contains instructions executable by said processor whereby the DSP apparatus is operative as follows. The DSP apparatus is operative to determine DL travel time compensations for DL data signals to be transmitted to a plurality of APs. The DL travel time compensations are based on the respective travel times and are configured to cause the DL data signals to be synchronized at said plurality of APs for coherent joint transmission by said plurality of APs to a same user equipment, UE. The apparatus is further configured to apply the DL travel time compensations to the DL data signals to be transmitted to said plurality of APs. Access points comprise radio frequency, RF, antenna apparatus, an optical receiver, an optical transmitter and a wavelength selective optical reflector The RF antenna apparatus is operative to transmit RF downlink, DL, data signals and to receive RF uplink, UL, data signals. The optical receiver is configured to receive DL fronthaul optical signals carrying DL data signals from the apparatus and to convert the DL fronthaul optical signals carrying DL data signals into RF DL data signals for transmission by the RF antenna apparatus. The optical transmitter is configured to receive UL RF data signals and to convert the UL RF data signals into UL fronthaul optical signals carrying UL data signals for transmission to the apparatus. The wavelength selective optical reflector configured to reflect optical interrogation signals received from the apparatus. The optical interrogation signals and the reflected optical interrogation signals travel in the same optical fibre links as at least one of the DL optical fronthaul signals or the UL optical fronthaul signals.

In an embodiment, the distributed multi-antenna communication system is a Distributed Multiple-Input Multiple-Output, D-MIMO, system.

Embodiments of the invention will now be described, by way of example only, with reference to the accompanying drawings.

### BRIEF DESCRIPTION OF THE DRAWINGS

FIGS. 1 to 11 are block diagrams illustrating embodiments of apparatus for a distributed multi-antenna communication system;

FIGS. 12 to 15 are block diagrams illustrating embodiments of an access point for a distributed multi-antenna communication system; and

FIGS. 16 and 17 are block diagrams illustrating embodiments of a distributed multi-antenna communication system.

### DETAILED DESCRIPTION

The same reference numbers are used for corresponding features in different embodiments.

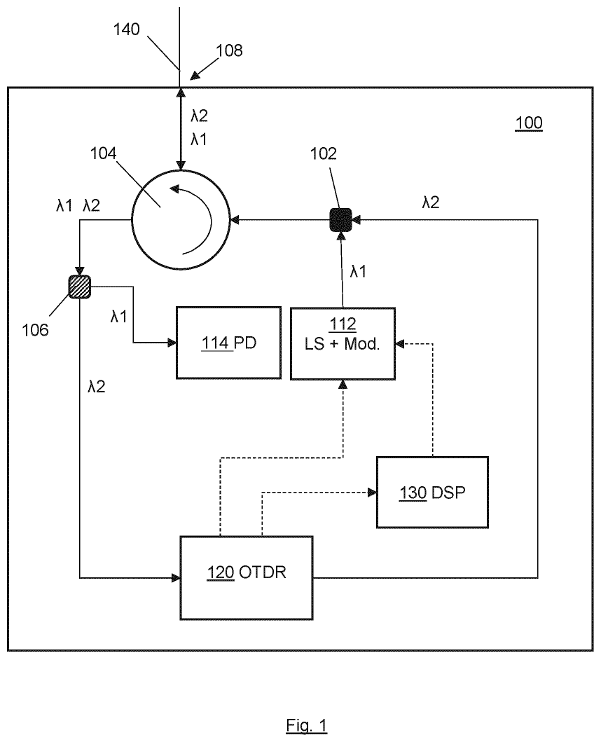

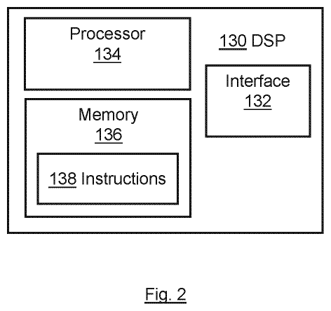

Referring to FIGS. 1 and 2, an embodiment provides an apparatus 100 for a distributed multi-antenna communication system. The apparatus 100 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 112 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 100 comprises optical time domain reflectometry, OTDR, apparatus 120, and digital signal processing, DSP, apparatus 130. The apparatus 100 has a single input-output port 108 configured for connection to a bi-directional optical fibre link 140.

The apparatus 100 is configured to route DL fronthaul optical signals at λ1 from the laser source, LS, and optical modulator unit 112 via an optical combiner 102 and an optical circulator 104 to the input-output port 108. The apparatus 100 is configured to route UL fronthaul optical signals, received at the input-output port 108, via the optical circulator 104 and a wavelength selective splitter 106 to the PD 114. The wavelength selective splitter may be based on either a micro-ring resonator or a Bragg grating.

The OTDR apparatus 120 is configured to transmit optical interrogation signals at a second, different, wavelength, λ2, to APs and to receive reflected optical interrogation signals at λ2 from APs. The OTDR apparatus is configured to determine, using the received reflected optical interrogation signals, respective travel times from the apparatus to APs. The OTDR may perform correlation analysis to determine travel times. The optical interrogations signals may be amplitude modulated optical signals or pulsed optical signals.

The apparatus 100 is configured to route optical interrogation signals at λ2 via the optical combiner 102 and the optical circulator 104 to the input-output port 108. The apparatus 100 is configured to route reflected optical interrogation signals, received at the input-output port 108, via the optical circulator 104 and the wavelength selective splitter 106 to the OTDR.

The DSP apparatus 130 comprises an interface 132, a processor 134 and memory 136. The memory contains instructions 138 executable by the processor whereby the DSP apparatus is operative to determine DL travel time compensations for DL data signals to be transmitted to a plurality of APs.

The DL travel time compensations are based on the respective travel times determined by the OTDR apparatus. The DL travel time compensations are configured to cause the DL data signals to be synchronized at the plurality of APs for coherent joint transmission by the plurality of APs to a same user equipment, UE.

The apparatus 100 is configured to apply the DL travel time compensations to the DL data signals to be transmitted to the plurality of APs.

The apparatus 100 is for use in a distributed multi-antenna communication system comprising a plurality of access points, APs, connected to the apparatus via bidirectional fronthaul, FH, optical fibre links 140. The UL/DL signals are exchanged via the same optical fibre in the two directions, and the same optical fibre is also used to transmit and receive the OTDR interrogation signals used to determine the round-trip travel time of an optical signal from the apparatus to each AP.

In order to manage the FH UL and DL optical signals and the OTDR signals, two different wavelengths are used: λ1 is associated to the FH optical signals and λ2 is associated to the OTDR signals. In the DL direction, the DL optical FH signal and the optical interrogation signal are combined in the optical combiner 102 and sent to output port 108 passing through the optical circulator 104. In the UL direction, the UL optical FH signal and the reflected optical interrogation signal received at the apparatus are separated by the wavelength selective splitter 106, then λ1 is used in the apparatus e.g. for channel estimation and all FH link communication whereas λ2 is used in the OTDR evaluation. The OTDR evaluation is used as feedback signal for the synchronization of the FH links reaching the different APs, to realize coherent joint transmission.

In an embodiment, the OTDR apparatus 120 is additionally configured to determine, using the received reflected optical interrogation signals, respective optical power losses between the apparatus and APs. The apparatus 100 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data. As will be well know to the skilled person, CPRI/eCPRI data flow comprise not only user plane data, but also vendor specific data, control plane data, and synchronization data. DL data signals and the UL data signals form part of the common public radio interface, CPRI, or evolved common public radio interface, eCPRI, information flows.

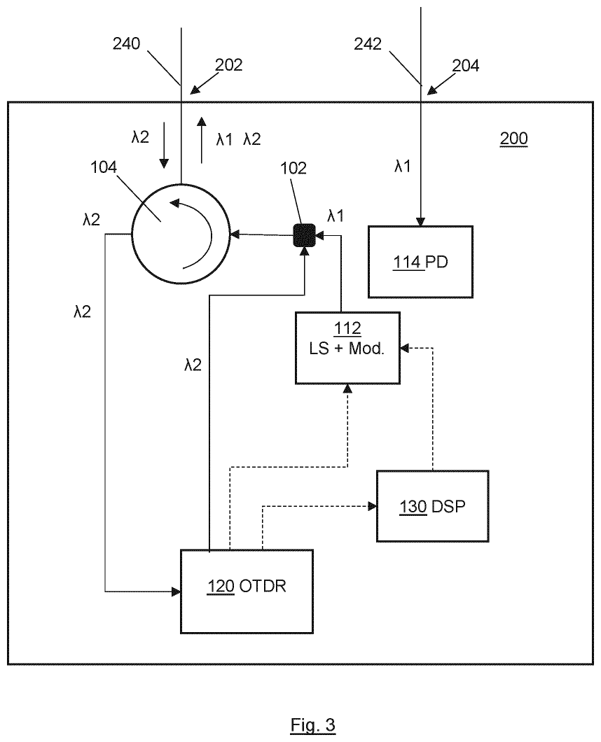

Referring to FIG. 3, an embodiment provides a apparatus 200 for a distributed multi-antenna communication system. The apparatus 200 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 112 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 200 comprises OTDR, apparatus 120, and DSP apparatus 130, as described above. The apparatus 200 has a first optical port 202 configured for connection to a DL optical fibre link 240 and a second optical port 204 configured for connection to an UL optical fibre link 242.

The apparatus 200 is configured to route DL fronthaul optical signals at a first wavelength, λ1, from the LS and optical modulator unit 112 via an optical combiner 102 and an optical circulator 104 to the first optical port 202. The apparatus 200 is configured to route UL fronthaul optical signals at λ1 received at the second optical port 204 to the PD 114.

The apparatus 200 is configured to route optical interrogation signals at λ2 from the OTDR via the optical combiner 102 and the optical circulator 104 to the first optical port 202. The apparatus 200 is configured to route reflected optical interrogation signals at λ2 received at the first optical port 202 via the optical circulator 104 to the OTDR.

The apparatus 200 is for use in a distributed multi-antenna communication system comprising a plurality of access points, APs, connected to the apparatus using dual-fibre fronthaul, FH, optical fibre links 240, 242, where the DL and UL optical fronthaul signals are delivered over separate optical fibres. The OTDR optical interrogation signal is sent over the DL optical fibre link 240. The OTDR signal is sent exploiting a different wavelength with respect with the FH optical signals, so that it is possible to reflect the optical interrogation signal at the AP without affecting the DL optical fronthaul signal. Then, the delay estimation is performed on the reflected optical interrogation signal received back over the DL optical fibre link 240.

In an embodiment, the OTDR apparatus 120 is additionally configured to determine, using the received reflected optical interrogation signals, respective optical power losses between the apparatus and APs. The apparatus 200 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

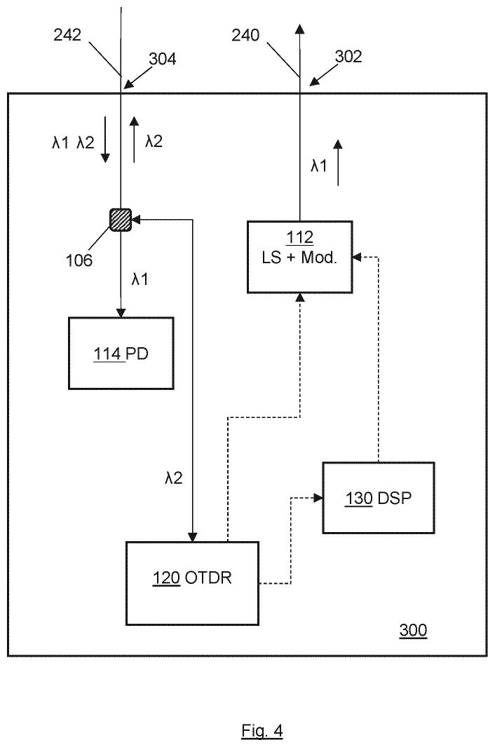

Referring to FIG. 4, an embodiment provides a apparatus 300 for a distributed multi-antenna communication system. The apparatus 300 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 112 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 300 comprises OTDR, apparatus 120, and DSP apparatus 130, as described above. The apparatus 300 has a first optical port 302 configured for connection to a DL optical fibre link 240 and a second optical port 304 configured for connection to an UL optical fibre link 242.

The apparatus 300 is configured to route DL fronthaul optical signals at a first wavelength, λ1, from the laser source, LS, and optical modulator unit 112 to the first optical port 302. The apparatus 300 is configured to route UL fronthaul optical signals at λ1 received at the second optical port 304 via a wavelength selective splitter 106 to the photodiode, PD, 114.

The apparatus 300 is configured to route optical interrogation signals at 12 from the OTDR 120 via the wavelength selective splitter 106 to the second optical port 304. The apparatus 300 is configured to route reflected optical interrogation signals at λ2 received at the second optical port 304 via the wavelength selective splitter 106 to the OTDR.

The apparatus 300 is for use in a distributed multi-antenna communication system comprising a plurality of access points, APs, connected to the apparatus using dual-fibre fronthaul, FH, optical fibre links 240, 242, where the DL and UL optical fronthaul signals are delivered over separate optical fibres. The optical interrogation signal is sent over the UL fibre link 242 exploiting a different wavelength with respect with the UL optical FH signal, so that it is possible to reflect the optical interrogation signal at the AP without affecting the UL optical fronthaul signal. Then, the delay estimation is performed on the reflected optical interrogation signal. In the apparatus, the incoming UL optical fronthaul signal and the reflected optical interrogation signal are separated via a wavelength selective splitter 106 e.g. based on ring resonators or Bragg gratings.

In an embodiment, the OTDR apparatus 120 is additionally configured to determine, using the received reflected optical interrogation signals, respective optical power losses between the apparatus and APs. The apparatus 300 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

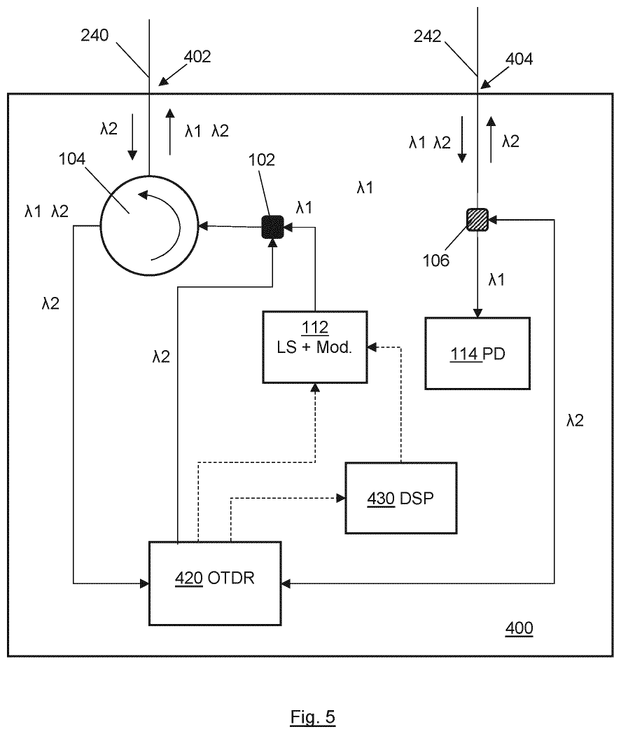

Referring to FIG. 5, an embodiment provides a apparatus, CU, 400 for a distributed multi-antenna communication system. The apparatus 400 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 112 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 400 comprises OTDR, apparatus 420, and DSP apparatus 430, generally as described above. The apparatus 400 has a first optical port 402 configured for connection to a DL optical fibre link 240 and a second optical port 404 configured for connection to an UL optical fibre link 242.

The apparatus 400 is configured to route DL fronthaul optical signals at a first wavelength, λ1, from the laser source, LS, and optical modulator unit 112 via an optical combiner 102 and an optical circulator 104 to the first optical port 402. The apparatus 400 is configured to route UL fronthaul optical signals at λ1 received at the second optical port 404 via a wavelength selective splitter 106 to the photodiode, PD, 114.

The apparatus 400 is configured to route first optical interrogation signals at λ2 from the OTDR 120 via the optical combiner 102 and the optical circulator 104 to the first optical port 402. The apparatus 400 is additionally configured to route second optical interrogation signals at λ2 from the OTDR 120 via a wavelength selective splitter 106 to the second optical port 404.

The apparatus 400 is configured to route reflected first optical interrogation signals at λ2 received at the first optical port 402 via the optical circulator 104 to the OTDR apparatus 120. The apparatus 400 is configured to route reflected second optical interrogation signals at λ2 received at the second optical port 404 via the wavelength selective splitter 106 to the OTDR apparatus 120.

The OTDR apparatus 420 is configured to determine, using the received reflected first and second optical interrogation signals, respective travel times from the apparatus to APs on each of the optical fibre links 240, 242. The OTDR may perform correlation analysis to determine travel times. The optical interrogations signals may be amplitude modulated optical signals or pulsed optical signals.

The DSP apparatus 430 is operative to determine DL travel time compensations for DL data signals to be transmitted to a plurality of APs.

The DL travel time compensations are based on the respective travel times determined by the OTDR apparatus for both optical fibre links 240, 242. The DL travel time compensations are configured to cause the DL data signals to be synchronized at the plurality of APs for coherent joint transmission by the plurality of APs to a same user equipment, UE. By determining the round trip travel time to each AP on each optical fibre link, more accurate DL travel time compensations can be determined.

The apparatus 400 is additionally configured to apply the DL travel time compensations to the DL data signals to be transmitted to the plurality of APs.

In an embodiment, the OTDR apparatus 420 is additionally configured to determine, using the received reflected optical interrogation signals, respective optical power losses between the apparatus and APs. The apparatus 400 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

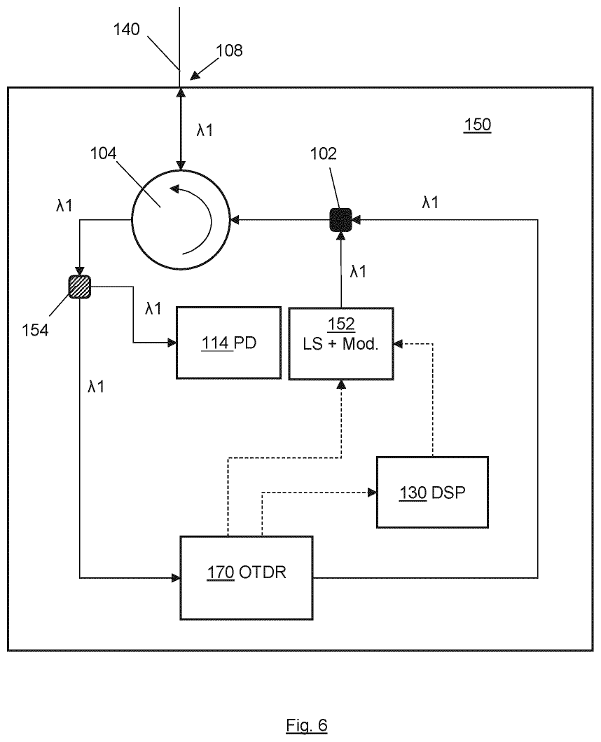

Referring to FIG. 6, an embodiment provides an apparatus 150 for a distributed multi-antenna communication system. The apparatus 150 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 150 comprises optical time domain reflectometry, OTDR, apparatus 170, and digital signal processing, DSP, apparatus 130. The apparatus 150 has a single input-output port 108 configured for connection to a bi-directional optical fibre link 140.

The apparatus 150 is configured to transmit DL fronthaul optical signals and receive UL fronthaul optical signals within first time slots. The apparatus 150 is configured to route DL fronthaul optical signals at λ1 from the LS and optical modulator unit 152 via an optical combiner 102 and an optical circulator 104 to the input-output port 108. The apparatus 150 is configured to route UL fronthaul optical signals, received at the input-output port 108, via the optical circulator 104 and an optical splitter 154 to the PD 114.

The OTDR apparatus 170 is configured to transmit optical interrogation signals at λ1 to APs and to receive reflected optical interrogation signals at λ1 from APs. The OTDR apparatus 170 is configured to transmit optical interrogation signals and receive reflected optical interrogation signals within second time slots, different to the first time slots.

The OTDR apparatus is configured to determine, using the received reflected optical interrogation signals, respective travel times from the apparatus to APs. The OTDR may perform correlation analysis to determine travel times. The optical interrogations signals may be amplitude modulated optical signals or pulsed optical signals.

The apparatus 150 is configured to route optical interrogation signals at λ1 from the OTDR apparatus 170 via the optical combiner 102 and the optical circulator 104 to the input-output port 108. The apparatus 150 is configured to route reflected optical interrogation signals, received at the input-output port 108, via the optical circulator 104 and the optical splitter 154 to the OTDR apparatus.

In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 170 is additionally configured to determine, using the received reflected optical interrogation signals, respective optical power losses between the apparatus and APs. The apparatus 150is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

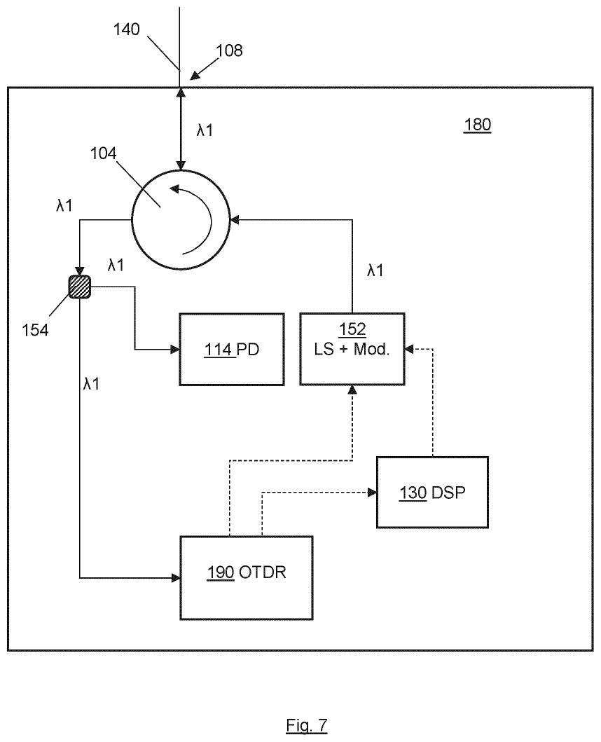

Referring to FIG. 7, an embodiment provides an apparatus 180 for a distributed multi-antenna communication system. The apparatus 180 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 180 comprises optical time domain reflectometry, OTDR, apparatus 190, and digital signal processing, DSP, apparatus 130. The CU 180 has a single input-output port 108 configured for connection to a bi-directional optical fibre link 140.

The apparatus 180 is configured to transmit DL fronthaul optical signals and receive UL fronthaul optical signals within first time slots.

The apparatus 180 is configured to route DL fronthaul optical signals at λ1 from the LS and optical modulator 152 via an optical circulator 104 to the input-output port 108. The apparatus 180 is configured to route UL fronthaul optical signals, received at the input-output port 108, via the optical circulator 104 and an optical splitter 154 to the PD 114.

The OTDR apparatus 190 is configured to generate a control signal to cause the LS and optical modulator 152 to transmit optical interrogation signals at λ1 to APs. The OTDR apparatus 190 is configured to receive reflected optical interrogation signals at λ1 from APs. The OTDR apparatus 190 is configured to cause optical interrogation signals to be transmitted by the LS and optical modulator 152 within second time slots, different to the first time slots. The OTDR apparatus 190 is configured to receive reflected optical interrogation signals within the second time slots.

The OTDR apparatus is configured to determine, using the received reflected optical interrogation signals, respective travel times from the apparatus to APs. The OTDR may perform correlation analysis to determine travel times. The optical interrogations signals may be amplitude modulated optical signals or pulsed optical signals.

The apparatus 180 is configured to route optical interrogation signals at λ1 from the LS and optical modulator 152 via the optical circulator 104 to the input-output port 108. The apparatus 180 is configured to route reflected optical interrogation signals, received at the input-output port 108, via the optical circulator 104 and the optical splitter 154 to the OTDR apparatus. In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 190 is additionally configured to determine, using the received reflected optical interrogation signals, respective optical power losses between the apparatus and APs. The apparatus 180 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

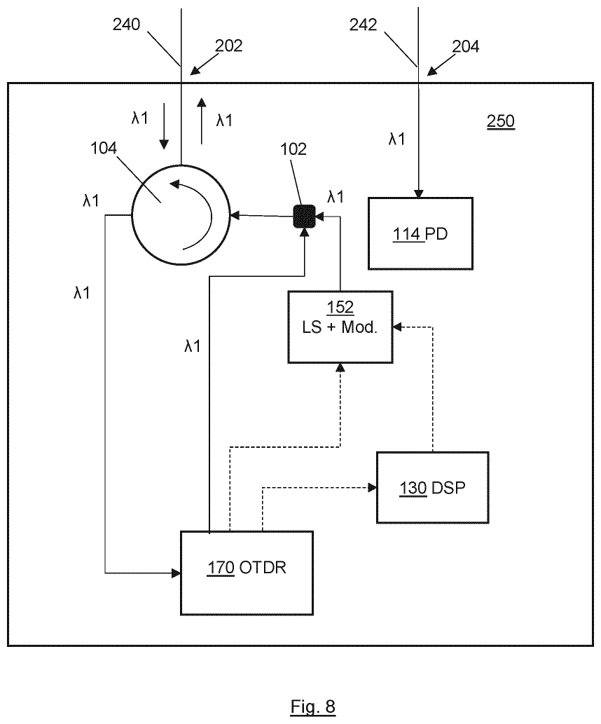

Referring to FIG. 8, an embodiment provides an apparatus 250 for a distributed multi-antenna communication system. The apparatus 250 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 250 comprises OTDR, apparatus 170, and DSP apparatus 130, as described above. The apparatus 250 has a first optical port 202 configured for connection to a DL optical fibre link 240 and a second optical port 204 configured for connection to an UL optical fibre link 242.

The apparatus 250 is configured to transmit DL fronthaul optical signals within first time slots and is configured to receive UL fronthaul optical signals within the first time slots.

The apparatus 250 is configured to route DL fronthaul optical signals at λ1 from the LS and optical modulator unit 152 via an optical combiner 102 and an optical circulator 104 to the first optical port 202. The apparatus 250 is configured to route UL fronthaul optical signals at λ1 received at the second optical port 204 to the PD 114.

The OTDR apparatus 170 is configured to transmit optical interrogation signals at λ1 to APs and to receive reflected optical interrogation signals at λ1 from APs. The OTDR apparatus 170 is configured to transmit optical interrogation signals and receive reflected optical interrogation signals within second time slots, different to the first time slots.

The apparatus 250 is configured to route optical interrogation signals at λ1 from the OTDR apparatus 170 via the optical combiner 102 and the optical circulator 104 to the first optical port 202. The apparatus 250 is configured to route reflected optical interrogation signals at λ1 received at the first optical port 202 via the optical circulator 104 to the OTDR apparatus.

In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 170 is additionally configured to determine, using the received reflected optical interrogation signals, respective optical power losses between the apparatus and APs. The apparatus 250 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

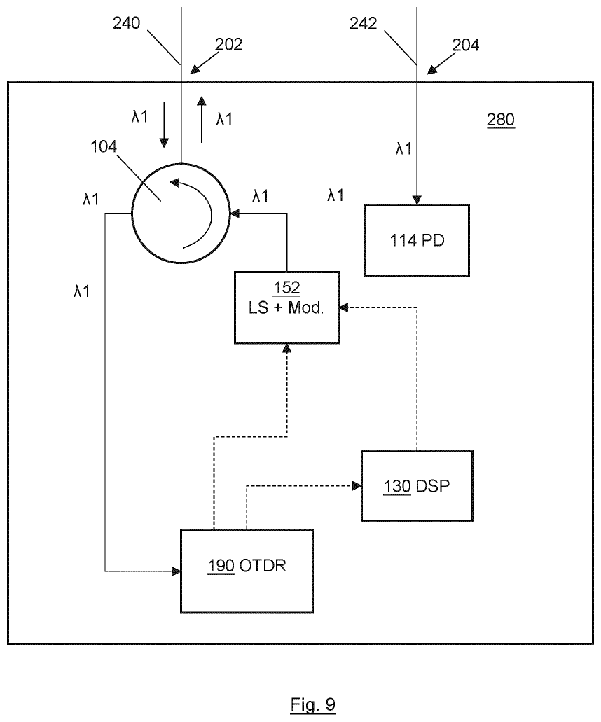

Referring to FIG. 9, an embodiment provides an apparatus 280 for a distributed multi-antenna communication system. The apparatus 280 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 280 comprises optical time domain reflectometry, OTDR, apparatus 190, and digital signal processing, DSP, apparatus 130. The apparatus 280 has a first optical port 202 configured for connection to a DL optical fibre link 240 and a second optical port 204 configured for connection to an UL optical fibre link 242.

The apparatus 280 is configured to transmit DL fronthaul optical signals within first time slots and is configured to receive UL fronthaul optical signals within the first time slots.

The apparatus 280 is configured to route DL fronthaul optical signals at λ1 from the LS and optical modulator unit 152 via an optical circulator 104 to the first optical port 202. The apparatus 280 is configured to route UL fronthaul optical signals at λ1 received at the second optical port 204 to the PD 114.

The OTDR apparatus 190 is configured to generate a control signal to cause the LS and optical modulator 152 to transmit optical interrogation signals at λ1 to APs. The OTDR apparatus 190 is configured to receive reflected optical interrogation signals at λ1 from APs. The OTDR apparatus 190 is configured to cause optical interrogation signals to be transmitted by the LS and optical modulator 152 within second time slots, different to the first time slots. The OTDR apparatus 190 is configured to receive reflected optical interrogation signals within the second time slots.

The OTDR apparatus is configured to determine, using the received reflected optical interrogation signals, respective travel times from the apparatus to APs. The OTDR may perform correlation analysis to determine travel times. The optical interrogations signals may be amplitude modulated optical signals or pulsed optical signals.

The apparatus 280 is configured to route optical interrogation signals at λ1 from the LS and optical modulator 152 via the optical circulator 104 to the first optical port 202. The apparatus 280 is configured to route reflected optical interrogation signals at λ1 received at the first optical port 202 via the optical circulator 104 to the OTDR apparatus.

In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 190 is additionally configured to determine, using the received reflected optical interrogation signals, respective optical power losses between the apparatus and APs. The apparatus 280 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

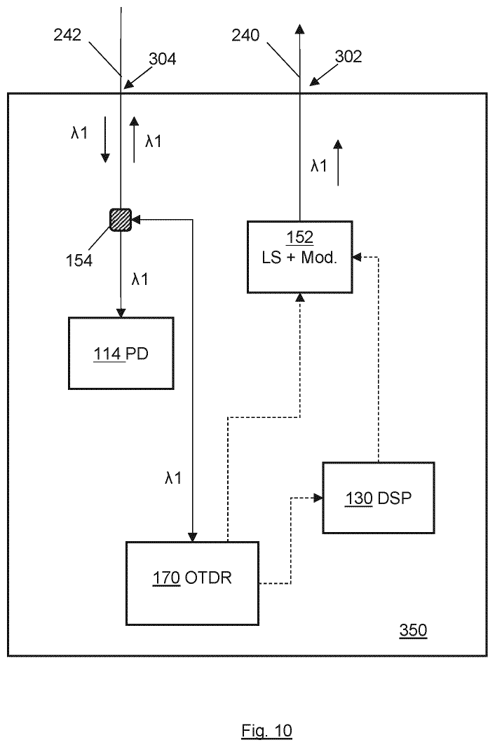

Referring to FIG. 10, an embodiment provides an apparatus 350 for a distributed multi-antenna communication system. The apparatus 350 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 350 comprises OTDR, apparatus 170, and DSP apparatus 130, as described above. The apparatus 350 has a first optical port 302 configured for connection to a DL optical fibre link 240 and a second optical port 304 configured for connection to an UL optical fibre link 242.

apparatus The apparatus 350 is configured to transmit DL fronthaul optical signals within first time slots and is configured to receive UL fronthaul optical signals within the first time slots.

The apparatus 350 is configured to route DL fronthaul optical signals at λ1 from the laser source, LS, and optical modulator unit 152 to the first optical port 302. The apparatus 350 is configured to route UL fronthaul optical signals at λ1 received at the second optical port 304 via an optical splitter 154 to the photodiode, PD, 114.

The OTDR apparatus 170 is configured to transmit optical interrogation signals at λ1 to APs and to receive reflected optical interrogation signals at λ1 from APs. The OTDR apparatus 170 is configured to transmit optical interrogation signals and receive reflected optical interrogation signals within second time slots, different to the first time slots.

The apparatus 350 is configured to route optical interrogation signals at λ1 from the OTDR apparatus 170 via the optical splitter 154 to the second optical port 304. The apparatus 350 is configured to route reflected optical interrogation signals at λ1 received at the second optical port 304 via the optical splitter 154 to the OTDR apparatus.

In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 170 is additionally configured to determine, using the received reflected optical interrogation signals, respective optical power losses between the apparatus and APs. The apparatus 350 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

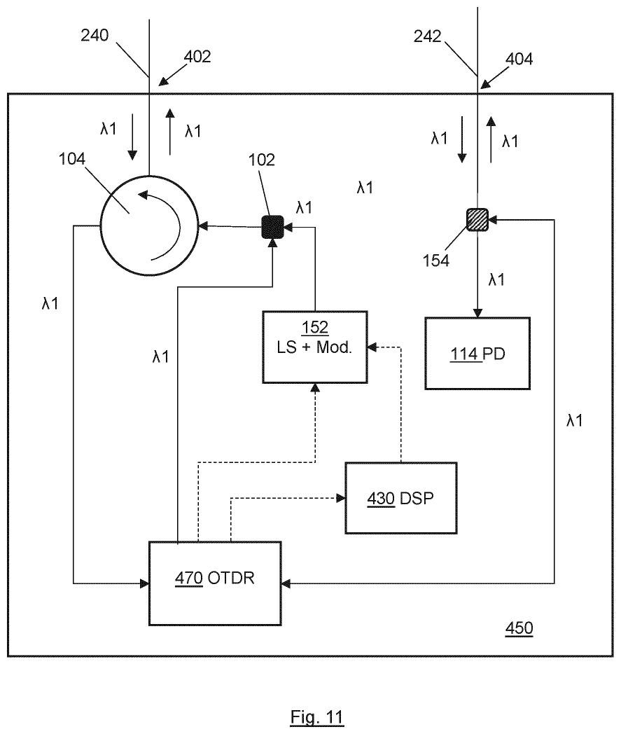

Referring to FIG. 11, an embodiment provides an apparatus 450 for a distributed multi-antenna communication system. The apparatus 450 is configured to transmit downlink, DL, data signals on DL fronthaul optical signals to access points, APs, and to receive uplink, UL, data signals on UL fronthaul optical signals from APs. The apparatus comprises a laser source, LS, and optical modulator unit 152 configured to generate DL fronthaul optical signals, at a first wavelength, λ1, carrying DL data signals. The apparatus additionally comprises a photodiode, PD, 114 configured to receive and detect UL fronthaul optical signals, at λ1, carrying UL data signals.

The apparatus 450 comprises OTDR, apparatus 470, and DSP apparatus 430, as described above. The apparatus 450 has a first optical port 402 configured for connection to a DL optical fibre link 240 and a second optical port 404 configured for connection to an UL optical fibre link 242.

The apparatus 450 is configured to transmit DL fronthaul optical signals within first time slots and is configured to receive UL fronthaul optical signals within the first time slots.

The apparatus 450 is configured to route DL fronthaul optical signals at λ1 from the laser source, LS, and optical modulator unit 152 via an optical combiner 102 and an optical circulator 104 to the first optical port 402. The apparatus 450 is configured to route UL fronthaul optical signals at λ1 received at the second optical port 404 via an optical splitter 154 to the photodiode, PD, 114.

The OTDR apparatus 470 is configured to transmit first and second optical interrogation signals at λ1 to APs and to receive reflected first and second optical interrogation signals at λ1 from APs. The OTDR apparatus 470 is configured to transmit optical interrogation signals and receive reflected optical interrogation signals within second time slots, different to the first time slots.

The apparatus 450 is configured to route first optical interrogation signals at λ1 from the OTDR apparatus 470 via the optical combiner 102 and the optical circulator 104 to the first optical port 402. The apparatus 450 is additionally configured to route second optical interrogation signals at λ1 from the OTDR apparatus 470 via the optical splitter 154 to the second optical port 404.

The apparatus 450 is configured to route reflected first optical interrogation signals at λ1 received at the first optical port 402 via the optical circulator 104 to the OTDR apparatus 470. The apparatus 450 is configured to route reflected second optical interrogation signals at λ1 received at the second optical port 404 via the optical splitter 154 to the OTDR apparatus 470.

The OTDR apparatus 470 is configured to determine, using the received reflected first and second optical interrogation signals, respective travel times from the apparatus to APs on each of the optical fibre links 240, 242. The OTDR apparatus may perform correlation analysis to determine travel times. The optical interrogations signals may be amplitude modulated optical signals or pulsed optical signals.

The DSP apparatus 430 is operative to determine DL travel time compensations for DL data signals to be transmitted to a plurality of APs.

The DL travel time compensations are based on the respective travel times determined by the OTDR apparatus for both optical fibre links 240, 242. The DL travel time compensations are configured to cause the DL data signals to be synchronized at the plurality of APs for coherent joint transmission by the plurality of APs to a same user equipment, UE. The DSP performed on the DL data signals applies the DL travel time compensations to the DL data signals. By determining the round trip travel time to each AP on each optical fibre link, more accurate DL travel time compensations can be determined.

The apparatus 450 is configured to apply the DL travel time compensations to the DL data signals to be transmitted to the plurality of APs.

In an embodiment, the second time slots have a duration equal to or longer than an optical round trip time to the AP located further from the apparatus, i.e. the round trip time for an optical interrogation signal from the apparatus to the AP of the plurality of APs that is located furthest from the apparatus and back to the apparatus.

In an embodiment, the OTDR apparatus 470 is additionally configured to determine, using the received reflected optical interrogation signals, respective optical power losses between the apparatus and APs. The apparatus 450 is additionally configured to modify optical powers of DL fronthaul optical signals to cause the optical powers of the DL fronthaul optical signals to be equalized at the plurality of APs.

In an embodiment, the DL data signals and the UL data signals comprise common public radio interface, CPRI, user plane data. In an alternative embodiment, the DL data signals and the UL data signals comprise evolved common public radio interface, eCPRI, user plane data.

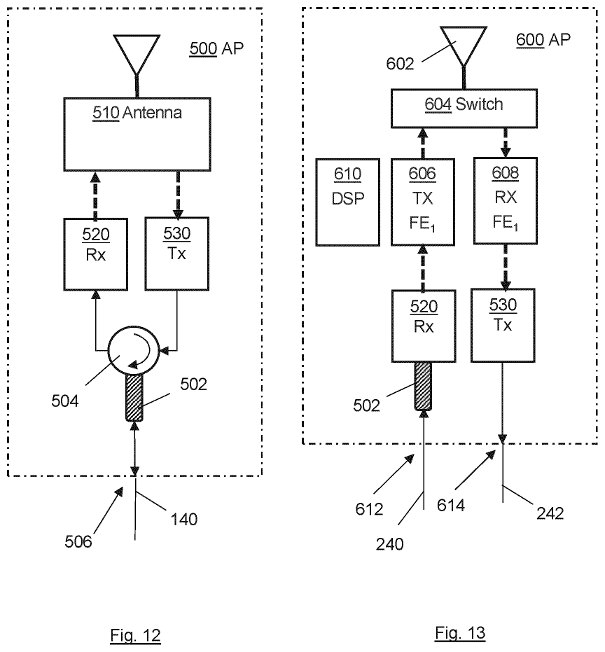

Referring to FIG. 12, an embodiment provides an access point, AP, 500 for a distributed multi-antenna communication system. The AP 500 comprises radio frequency, RF, antenna apparatus 510, an optical receiver 520, an optical transmitter 530 and a wavelength selective optical reflector 502.

The RF antenna apparatus 510 is operative to transmit RF downlink, DL, data signals and to receive RF uplink, UL, data signals. The optical receiver 520 is configured to receive DL fronthaul optical signals carrying DL data signals from an apparatus configured to transmit downlink, DL, data signals on DL fronthaul optical signals to access points, APs, and to receive uplink, UL, data signals on UL fronthaul optical signals from APs. The optical receiver 520 is configured to convert the DL fronthaul optical signals carrying DL data signals into RF DL data signals for transmission by the RF antenna apparatus. The optical transmitter 530 is configured to receive UL RF data signals and to convert the UL RF data signals into UL fronthaul optical signals carrying UL data signals for transmission to the apparatus. The wavelength selective optical reflector 502 is configured to reflect optical interrogation signals received from the apparatus.

The AP 500 has a single optical input/output port 506 connected to the optical receiver 520 and the optical transmitter 530 via an optical circulator 504. The input/output port is configured for connection to a bi-directional optical fibre link 140. The wavelength selective optical reflector 502 is provided at the input/output port.

The optical receiver 520 is configured to receive DL fronthaul optical signals at a first wavelength, λ1, the optical transmitter 530 is configured to transmit UL fronthaul optical signals at λ1, and the wavelength selective optical reflector 502 is configured to reflect optical interrogation signals at a second, different, wavelength, λ2.

In an alternative embodiment, the wavelength selective optical reflector 502 is configured to reflect optical interrogation signals at the first wavelength, λ1. The optical receiver 520 is configured to receive DL fronthaul optical signals within first time slots and the optical transmitter 530 is configured to transmit UL fronthaul optical signals within the first time slots. Optical interrogation signals are received within second time slots, different to the first time slots. The wavelength selective optical reflector 502 is configured to transmit a first percentage of optical signals received at λ1 and is configured to reflect a second, smaller, percentage of optical signals received at λ1. For example, the wavelength selective optical reflector 502 may be configured to transmit 80-90% of optical signals received at λ1 and to reflect 10-20% of optical signals received at λ1.

In an alternative embodiment, the wavelength selective optical reflector 502 is reconfigurable between a transmission state in the first time slots, in which DL fronthaul optical signals at λ1 are transmitted, and a reflection state in the second time slots, in which optical interrogation signals at λ1 are reflected.

The wavelength selective optical reflector 502 may, for example, be a fibre Bragg grating or an integrated Bragg grating structure.

Referring to FIG. 13, an embodiment provides an access point, AP, 600 for a distributed multi-antenna communication system. The AP 600 comprises radio frequency, RF, antenna apparatus, an optical receiver 520, an optical transmitter 530, digital signal processing, DSP, apparatus 610 and a wavelength selective optical reflector 502.

The RF antenna apparatus comprises an RF antenna 602, a switch 604 and RF front end, FE, circuitry comprising RF FE transmitter, TX, circuitry 606 and RF FE receiver, RX, circuitry 608. The RF FE TX circuitry is configured to receive RF DL data signals from the optical receiver 520 and to process the RF DL data signals for transmission by the RF antenna 602. The RF FE RX circuitry is configured to receive RF UL data signals from the RF antenna and to process them for transmission by the optical transmitter. The switch 604 is operative to support time division duplex, TDD, operation of the RF antenna.

The DSP apparatus 610 is configured to compensate for amplitude and phase changes caused to the RF DL data signals by the RF FE TX circuitry.

The AP 600 has a first optical port 612 connected to the optical receiver 520 and a second optical port 614 connected to the optical transmitter 530. The first optical port is configured for connection to a DL optical fibre link 240. The second optical port is configured for connection to an UL optical fibre link 242. The wavelength selective optical reflector 502 is provided at the first optical port.

The optical receiver 520 is configured to receive DL fronthaul optical signals at a first wavelength, λ1, the optical transmitter 530 is configured to transmit UL fronthaul optical signals at λ1, and the wavelength selective optical reflector 502 is configured to reflect optical interrogation signals at a second, different, wavelength, λ2.

In an alternative embodiment, the wavelength selective optical reflector 502 is configured to reflect optical interrogation signals at the first wavelength, λ1. The optical receiver 520 is configured to receive DL fronthaul optical signals within first time slots and the optical transmitter 530 is configured to transmit UL fronthaul optical signals within the first time slots. The wavelength selective optical reflector 502 is configured to transmit a first percentage of optical signals received at λ1 and is configured to reflect a second, smaller, percentage of optical signals received at λ1. For example, the wavelength selective optical reflector 502 may be configured to transmit 80-90% of optical signals received at λ1 and to reflect 10-20% of optical signals received at λ1.

In an alternative embodiment, the wavelength selective optical reflector 502 is reconfigurable between a transmission state in the first time slots, in which DL fronthaul optical signals at λ1 are transmitted, and a reflection state in the second time slots, in which optical interrogation signals at λ1 are reflected.

The wavelength selective optical reflector 502 may, for example, be a fibre Bragg grating or an integrated Bragg grating structure.

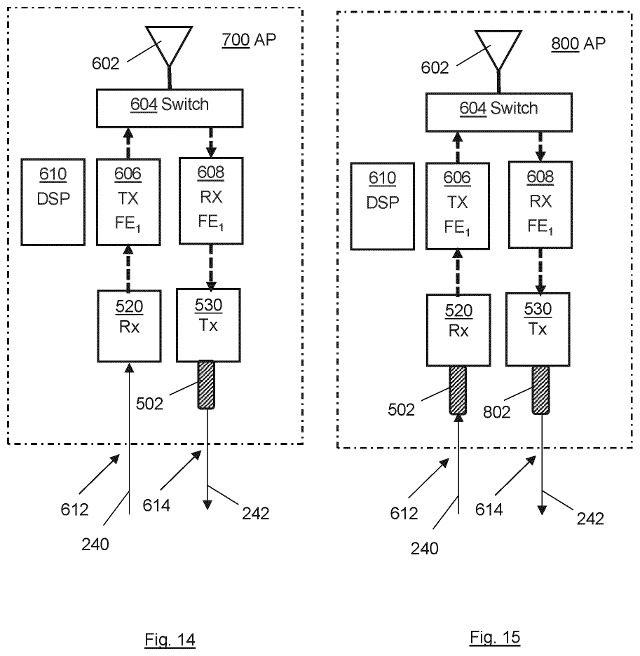

Referring to FIG. 14, an embodiment provides an access point, AP, 700 for a distributed multi-antenna communication system. The AP 700 comprises radio frequency, RF, antenna apparatus, an optical receiver 520, an optical transmitter 530, digital signal processing, DSP, apparatus 610 and a wavelength selective optical reflector 502.

In this embodiment, the wavelength selective optical reflector 502 is provided at the second optical port.

The optical receiver 520 is configured to receive DL fronthaul optical signals at a first wavelength, λ1, the optical transmitter 530 is configured to transmit UL fronthaul optical signals at λ1, and the wavelength selective optical reflector 502 is configured to reflect optical interrogation signals at a second, different, wavelength, λ2.

In an alternative embodiment, the wavelength selective optical reflector 502 is configured to reflect optical interrogation signals at the first wavelength, λ1. The optical receiver 520 is configured to receive DL fronthaul optical signals within first time slots and the optical transmitter 530 is configured to transmit UL fronthaul optical signals within the first time slots. The wavelength selective optical reflector 502 is configured to transmit a first percentage of optical signals received at λ1 and is configured to reflect a second, smaller, percentage of optical signals received at λ1. For example, the wavelength selective optical reflector 502 may be configured to transmit 80-90% of optical signals received at λ1 and to reflect 10-20% of optical signals received at λ1.

In an alternative embodiment, the wavelength selective optical reflector 502 is reconfigurable between a transmission state in the first time slots, in which DL fronthaul optical signals at λ1 are transmitted, and a reflection state in the second time slots, in which optical interrogation signals at λ1 are reflected.

The wavelength selective optical reflector 502 may, for example, be a fibre Bragg grating or an integrated Bragg grating structure.

Referring to FIG. 15, an embodiment provides an access point, AP, 800 for a distributed multi-antenna communication system. The AP 800 comprises radio frequency, RF, antenna apparatus, an optical receiver 520, an optical transmitter 530, digital signal processing, DSP, apparatus 610 and a first wavelength selective optical reflector 502, and a second wavelength selective optical reflector 802.

The first wavelength selective optical reflector 502 is provided at the first optical port 612 and the second wavelength selective optical reflector 802 is provided at the second optical port 614.

The optical receiver 520 is configured to receive DL fronthaul optical signals at a first wavelength, λ1, the optical transmitter 530 is configured to transmit UL fronthaul optical signals at λ1, and the wavelength selective optical reflectors 502, 802 are configured to reflect optical interrogation signals at a second, different, wavelength, λ2.

In an alternative embodiment, the wavelength selective optical reflectors 502, 802 are configured to reflect optical interrogation signals at the first wavelength, λ1. The optical receiver 520 is configured to receive DL fronthaul optical signals within first time slots and the optical transmitter 530 is configured to transmit UL fronthaul optical signals within the first time slots. The wavelength selective optical reflectors 502, 802 re configured to transmit a first percentage of optical signals received at λ1 and is configured to reflect a second, smaller, percentage of optical signals received at λ1. For example, the wavelength selective optical reflectors 502, 802 may be configured to transmit 80-90% of optical signals received at λ1 and to reflect 10-20% of optical signals received at λ1.

In an alternative embodiment, the wavelength selective optical reflectors 502, 802 are reconfigurable between a transmission state in the first time slots, in which DL fronthaul optical signals at λ1 are transmitted, and a reflection state in the second time slots, in which optical interrogation signals at λ1 are reflected.

The wavelength selective optical reflectors 502, 802 may, for example, be a fibre Bragg grating or an integrated Bragg grating structure.

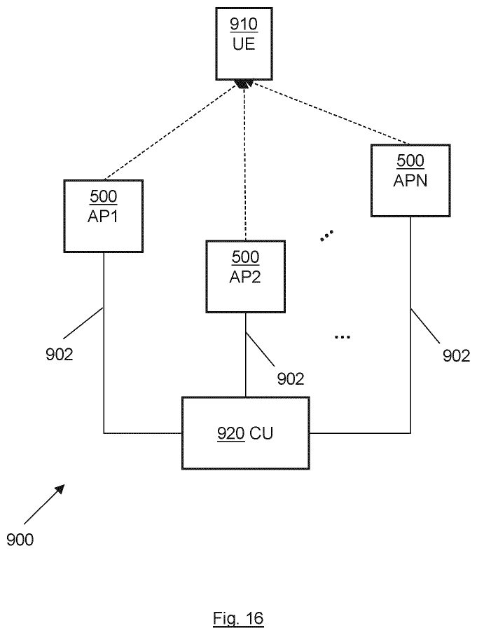

Referring to FIG. 16, an embodiment provides a distributed multi-antenna communication system 900 comprising an apparatus 920 configured to transmit downlink, DL, data signals on DL fronthaul optical signals to access points, APs, a plurality of APs 500, 600, 700, 800 as described above, and a plurality of optical fibre links 902 connecting the apparatus to the APs.

In this embodiment, the apparatus 920 is a central unit, CU. The apparatus 920 may be an apparatus 100, 150, 180, 200, 250, 280, 300, 350, 400, 450, as described above with reference to any one of FIGS. 1 to 11,

The optical interrogation signals and the reflected optical interrogation signals travel in the same optical fibre links as at least one of the DL optical fronthaul signals or the UL optical fronthaul signals.

A plurality of the APs 500, 600, 700, 800 are configured to transmit to a same UE 910.

The APs receive the DL data signal to be transmitted from the CU. The centralized processing and control at the CU synchronizes the fronthaul delay contribution by a precise determination of the time lag of the signal from the CU to each AP. Such time lag determination is enabled via OTDR, which is performed on the same fibre used by the FH link.

TDD operation is assumed at the APs, e.g., use of switches. To achieve CJT, explicit knowledge of the channel is needed, thus, reciprocity-based channel estimation in TDD systems is chosen.

In the DL direction of the FH link, the CU transmits a digital DL data signal on an optical fronthaul signal, by modulating the LS with an optical modulator. Alternatively, the CU may directly modulate the LS. The DL optical fronthaul signal carrying the DL digital data signal reaches the AP over the optical fibre link and is converted into an analog RF signal by the optical receiver in the AP.

In the UL direction, the AP converts a received analog RF signal into an UL digital data signal and transmits it over an UL fronthaul optical signal to the CU over the optical fibre link.

The OTDR apparatus exploits the same fibre used by the FH link to determine the time required for the optical signal to travel the optical fibre link from the CU to the AP, and back, which may vary with fibre length to the AP and temperature, among other factors, and therefore it requires a frequent determination to guarantee a correct compensation. This compensation is performed for each AP and allows to synchronize the AP RF signals as required by CJT. This avoids complex calibration of the AP involved in the joint transmission.

The CU performs the signal processing, including channel estimation and OTDR functions, so that the complexity required at the AP is reduced. This is important to reduce overall system costs, as a D-MIMO deployment requires a massive number of APs.

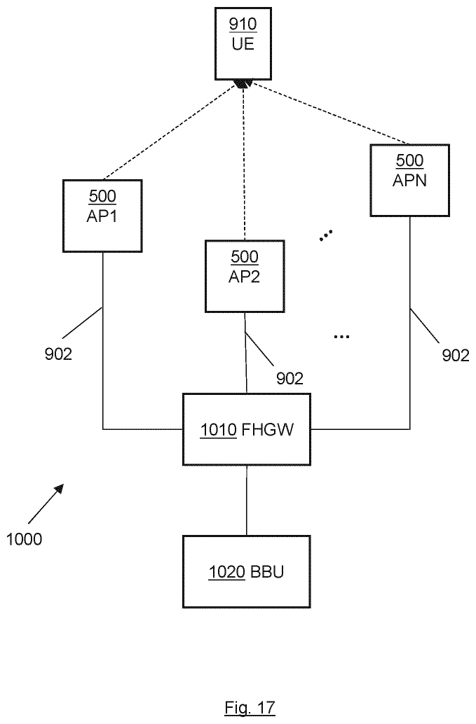

Referring to FIG. 17, an embodiment provides a distributed multi-antenna communication system 1000 comprising a baseband unit, BBU, 1020, an apparatus 1010 configured to transmit downlink, DL, data signals on DL fronthaul optical signals to access points, APs, a plurality of APs 500, 600, 700, 800 as described above, and a plurality of optical fibre links 902 connecting the apparatus to the APs.

In this embodiment, the apparatus 1010 is a fronthaul gateway, FHGW. The apparatus 1010 may be an apparatus 100, 150, 180, 200, 250, 280, 300, 350, 400, 450, as described above with reference to any one of FIGS. 1 to 11.

The optical interrogation signals and the reflected optical interrogation signals travel in the same optical fibre links as at least one of the DL optical fronthaul signals or the UL optical fronthaul signals.

A plurality of the APs 500, 600, 700, 800 are configured to transmit to a same UE 910. The APs receive the DL data signal to be transmitted from the FHGW. The centralized processing and control at the FHGW synchronizes the fronthaul delay contribution by a precise determination of the time lag of the signal from the FHGW to each AP. Such time lag determination is enabled via OTDR, which is performed on the same fibre used by the FH link. TDD operation is assumed at the APs, e.g., use of switches. To achieve CJT, explicit knowledge of the channel is needed, thus, reciprocity-based channel estimation in TDD systems is chosen.

In the DL direction of the FH link, the FHGW transmits a digital DL data signal on an optical fronthaul signal, by modulating the LS with an optical modulator. Alternatively, the FHGW may directly modulate the LS. The DL optical fronthaul signal carrying the DL digital data signal reaches the AP over the optical fibre link and is converted into an analog RF signal by the optical receiver in the AP.

In the UL direction, the AP converts a received analog RF signal into an UL digital data signal and transmits it over an UL fronthaul optical signal to the FHGW over the optical fibre link.

The OTDR apparatus exploits the same fibre used by the FH link to determine the time required for the optical signal to travel the optical fibre link from the FHGW to the AP, and back, which may vary with fibre length to the AP and temperature, among other factors, and therefore it requires a frequent determination to guarantee a correct compensation. This compensation is performed for each AP and allows to synchronize the AP RF signals as required by CJT. This avoids complex calibration of the AP involved in the joint transmission.

The FHGW performs the signal processing, including channel estimation and OTDR functions, so that the complexity required at the AP is reduced. This is important to reduce overall system costs, as a D-MIMO deployment requires a massive number of APs.

This embodiment may be used in a Cloud RAN network.

In an embodiment, the optical fibre links 902 are bi-directional optical fibre links. The CU or FHGW is an apparatus 100 as described with reference to FIG. 1 and the APs are APs 500 as described with reference to FIG. 12, wherein the wavelength selective optical reflector 502 is configured to reflect optical interrogation signals at a second, different, wavelength, λ2. In an alternative embodiment, the optical fibre links 902 are bi-directional optical fibre links. The CU or FHGW is an apparatus 150 as described with reference to FIG. 6 or an apparatus 180 as described in FIG. 7 and the APs are APs 500 as described with reference to FIG. 12, wherein the wavelength selective optical reflector 502 is configured to reflect optical interrogation signals at λ1.

In an embodiment, the optical fibre links 902 are dual-fibre optical fibre links where the DL and UL optical fronthaul signals are delivered over separate optical fibres 240, 242. The CU or FHGW is an apparatus 200 as described with reference to FIG. 3. The APs are APs 600 as described with reference to FIG. 13, wherein the wavelength selective optical reflector 502 is configured to reflect optical interrogation signals at a second, different, wavelength, λ2.

In an alternative embodiment, the optical fibre links 902 are dual-fibre optical fibre links where the DL and UL optical fronthaul signals are delivered over separate optical fibres 240, 242. The CU or FHGW is an apparatus 250 as described with reference to FIG. 8 or a CU 280 as described in FIG. 9. The APs are APs 600 as described with reference to FIG. 13, wherein the wavelength selective optical reflector 502 is configured to reflect optical interrogation signals at λ1.

In an embodiment, the optical fibre links 902 are dual-fibre optical fibre links where the DL and UL optical fronthaul signals are delivered over separate optical fibres 240, 242. The CU or FHGW is an apparatus 300 as described with reference to FIG. 4. The APs are APs 700 as described with reference to FIG. 14, wherein the wavelength selective optical reflector 502 is configured to reflect optical interrogation signals at a second, different, wavelength, λ2.

In an alternative embodiment, the optical fibre links 902 are dual-fibre optical fibre links where the DL and UL optical fronthaul signals are delivered over separate optical fibres 240, 242. The CU or FHGW is an apparatus 350 as described with reference to FIG. 10. The APs are APs 700 as described with reference to FIG. 14, wherein the wavelength selective optical reflector 502 is configured to reflect optical interrogation signals at 21.

In an embodiment, the optical fibre links 902 are dual-fibre optical fibre links where the DL and UL optical fronthaul signals are delivered over separate optical fibres 240, 242. The CU or FHGW is an apparatus 400 as described with reference to FIG. 5. The APs are APs 800 as described with reference to FIG. 15, wherein the first wavelength selective optical reflector 502 and the second wavelength selective optical reflector 802 are configured to reflect optical interrogation signals at a second, different, wavelength, λ2.

In an alternative embodiment, the optical fibre links 902 are dual-fibre optical fibre links where the DL and UL optical fronthaul signals are delivered over separate optical fibres 240, 242. The CU or FHGW is an apparatus 450 as described with reference to FIG. 11. The APs are APs 800 as described with reference to FIG. 16, wherein the wavelength selective optical reflectors 502, 802 are configured to transmit a first percentage of optical signals received at λ1 and is configured to reflect a second, smaller, percentage of optical signals received at λ1. For example, the wavelength selective optical reflectors 502, 802 may be configured to transmit 80-90% of optical signals received at λ1 and to reflect 10-20% of optical signals received at λ1.

In alternative embodiments, applicable to various network architectures, the apparatus for use in a distributed multi-antenna communication system may comprise a baseband unit, a centralised unit, a distributed unit or a fronthaul gateway that may be connected between any of the units mentioned before and access points.

In an alternative embodiment, the wavelength selective optical reflectors 502, 802 are reconfigurable between a transmission state in the first time slots, in which DL fronthaul optical signals at λ1 are transmitted, and a reflection state in the second time slots, in which optical interrogation signals at λ1 are reflected.

1. An apparatus for use in a distributed multi-antenna communication system, the apparatus configured to transmit downlink (DL) data signals on DL fronthaul optical signals to a plurality of access points (APs) and receive uplink (UL) data signals on UL fronthaul optical signals from APs, the apparatus comprising:
an optical time domain reflectometry (OTDR) apparatus configured to:
transmit optical interrogation signals to the APs;
receive reflected optical interrogation signals from the APs; and
determine, using the received reflected optical interrogation signals, respective travel times from the apparatus to the APs; and
digital signal processing (DSP) circuitry configured to determine, for DL data signals to be transmitted to the APs, DL travel time compensations for DL data signals based on the respective travel times such that the DL data signals are synchronized at the APs for coherent joint transmission by the APs to a same user equipment (UE);
wherein the apparatus is further configured to apply the DL travel time compensations to the DL data signals to be transmitted to the APs.

2. The apparatus of claim 1, wherein the optical interrogations signals are one of amplitude modulated optical signals or pulsed optical signals.

3. The apparatus of claim 1, wherein:
the OTDR apparatus is further configured to determine, using the received reflected optical interrogation signals, respective optical power losses between the apparatus and the APs; and
the apparatus is further configured to modify optical powers of DL fronthaul optical signals to cause the optical powers of the DL fronthaul optical signals to be equalized at said plurality of APs.

4. The apparatus of claim 1, wherein the DL data signals and the UL data signals comprise one of common public radio interface (CPRI) or evolved common public radio interface (eCPRI) user plane data.

5. The apparatus of claim 1, wherein the apparatus has a single optical input/output port configured for connection to a bi-directional optical fibre link, and wherein the apparatus is configured to output DL fronthaul optical signals and optical interrogation signals through the input/output port and the apparatus is configured to receive UL fronthaul optical signals and reflected optical interrogation signals through the input/output port.

6. The apparatus of claim 1, wherein:
the apparatus further comprises a first optical port configured for connection to a DL optical fibre link and a second optical port configured for connection to an UL optical fibre link; and
the apparatus is configured to:
output DL fronthaul optical signals through the first optical port;
receive UL fronthaul optical signals through the second optical port; and
output optical interrogation signals and receive reflected optical interrogation signals through one of the first optical port or the second optical port.

7. The apparatus of claim 5, wherein:
the DL fronthaul optical signals and the UL fronthaul optical signals are at a first wavelength, l1;
the optical interrogation signals and the reflected optical interrogation signals are at a second, different, wavelength, l2; and
the apparatus further comprises a wavelength selective router configured to separate reflected optical interrogation signals from UL fronthaul optical signals and to route reflected optical interrogation signals to the OTDR apparatus.

8. The apparatus of claim 5, wherein:
the apparatus is configured to transmit DL fronthaul optical signals and receive UL fronthaul optical signals within first time slots; and
the OTDR apparatus is configured to transmit optical interrogation signals and receive reflected optical interrogation signals within second time slots, different to the first time slots.

9. The apparatus of claim 8, wherein the second time slots have a duration equal to or longer than an optical round trip time of a said optical interrogation signal from the apparatus to a respective AP of said plurality of APs located furthest from the apparatus and back to the apparatus.

10. The apparatus of claim 1, wherein the distributed multi-antenna communication system is a Distributed Multiple-Input Multiple-Output (D-MIMO) system.

11. The apparatus of claim 1, wherein the apparatus is one of a central unit (CU) or a fronthaul gateway (FHGW).

12. An access point for a distributed multi-antenna communication system, the access point comprising:
a radio frequency (RF) antenna apparatus operative to transmit RF downlink (DL) data signals and to receive RF uplink (UL) data signals;
an optical receiver configured to receive DL fronthaul optical signals carrying DL data signals from a apparatus and to convert the DL fronthaul optical signals carrying DL data signals into RF DL data signals for transmission by the RF antenna apparatus;
an optical transmitter configured to receive UL RF data signals and to convert the UL RF data signals into UL fronthaul optical signals carrying UL data signals for transmission to the apparatus; and
a wavelength selective optical reflector configured to reflect optical interrogation signals received from the apparatus.

13. The access point of claim 12, wherein:
the RF antenna apparatus comprises an RF antenna and RF front end circuitry configured to receive RF DL data signals from the optical receiver and to process the RF DL data signals for transmission by the RF antenna; and
the access point further comprises digital signal processing (DSP) circuitry configured to compensate for amplitude and phase changes caused to the RF DL data signals by the RF front end circuitry.

14. The access point of claim 12, wherein:
the optical receiver is configured to receive DL fronthaul optical signals at a first wavelength, l1;
the optical transmitter is configured to transmit UL fronthaul optical signals at l1; and
the wavelength selective optical reflector is configured to reflect one of optical interrogation signals at the first wavelength, l1, or optical interrogation signals at a second, different, wavelength, l2.

15. The access point of claim 14, wherein the access point has a single optical input/output port connected to the optical receiver and the optical transmitter, the input/output port is configured for connection to a bi-directional optical fibre link and the wavelength selective optical reflector is provided at the input/output port.

16. The access point of claim 14, wherein the access point has a first optical port connected to the optical receiver and configured for connection to a DL optical fibre link, and a second optical port connected to the optical transmitter and configured for connection to an UL optical fibre link, and wherein the wavelength selective optical reflector is provided at one of the first optical port or the second optical port.

17. The access point of claim 16, further comprising a second wavelength selective optical reflector configured to reflect optical interrogation signals at a same wavelength as the first wavelength selective optical reflector, wherein the wavelength selective optical reflector is provided at the first optical port and the second wavelength selective optical reflector is provided at the second optical port.

18. The access point of claim 12, wherein the distributed multi-antenna communication system is a Distributed Multiple-Input Multiple-Output (D-MIMO) system.

19. A distributed multi-antenna communication system comprising:
an apparatus comprising:
an optical time domain reflectometry (OTDR) apparatus configured to:
transmit optical interrogation signals to a plurality of access points (APs);
receive reflected optical interrogation signals from the APs; and
determine, using the received reflected optical interrogation signals, respective travel times from the apparatus to the APs; and
digital signal processing (DSP) circuitry configured to determine, for downlink (DL) data signals to be transmitted to the APs, DL travel time compensations based on the respective travel times such that the DL data signals are synchronized at the APs for coherent joint transmission by the APs to a same user equipment (UE);
the APs, each AP comprising:
a radio frequency (RF) antenna apparatus configured to transmit RF DL data signals and to receive RF uplink (UL) data signals;
an optical receiver configured to receive DL fronthaul optical signals carrying the DL data signals from the apparatus and to convert the DL fronthaul optical signals carrying the DL data signals into RF DL data signals for transmission by the RF antenna apparatus;
an optical transmitter configured to receive UL RF data signals and to convert the UL RF data signals into UL fronthaul optical signals carrying UL data signals for transmission to the apparatus; and
a wavelength selective optical reflector configured to reflect the optical interrogation signals received from the apparatus; and
a plurality of optical fibre links connecting the apparatus to the APs, wherein the optical interrogation signals and the reflected optical interrogation signals travel in the same optical fibre links as at least one of the DL optical fronthaul signals or the UL optical fronthaul signals;
wherein the apparatus is further configured to apply the DL travel time compensations to the DL data signals to be transmitted to the APs.

20. The distributed multi-antenna communication system of claim 19, wherein the distributed multi-antenna communication system is a Distributed Multiple-Input Multiple-Output (D-MIMO) system.
